(19) United States
(12) Patent Application Publication
(10) Pub. No.: US 2024/0102509 A1
(43) Pub. Date: Mar. 28, 2024

(54) Fall-Proof Graduated Cylinders

(71) Applicant: Wesley Yiming Liu, Warren, NJ (US)

(72) Inventor: Wesley Yiming Liu, Warren, NJ (US)

(21) Appl. No.: 18/225,605

(22) Filed: Jul. 24, 2023

Related U.S. Application Data
(60) Provisional application No. 63/369,247, filed on Jul. 24, 2022.

(51) Int. Cl. F16B 47/00

(52) U.S. Cl. CPC F16B 47/00; G01F 19/00

(57) ABSTRACT

A graduated cylinder is provided in this invention that can stand securely and releasably in an upright position to prevent the cylinder from being toppled over. By securing the graduated cylinder when needed, both the hazards from glass breakage and chemical spills can be prevented. By providing mechanisms for releasing the graduated cylinder when needed, it can be moved or transported.

This application claims the benefit of U.S. Provisional Application No. 63/369,247, filed on Jul. 24, 2022.

### BACKGROUND

Graduated cylinders are tall, narrow, cylindrical vessels that are used to measure the volumes of liquids, often in a laboratory environment. Liquid is poured into the graduated cylinder of appropriate size for the expected volume, and then the liquid's volume is measured by observation of the liquid's top level against the incremental markings on the graduated cylinder. Graduated cylinders are most often made of glass, and sometimes plastic.

While graduated cylinders are common in laboratories, they pose many hazards. Due to the graduated cylinders' height and narrow structures, they have a high center of mass and can easily be toppled over accidentally. Toppling a graduated cylinder can result in the glass chipping or completely shattering, breaking the graduated cylinder and scattering small, sharp glass shards in the vicinity. Liquids inside the graduated cylinder will also disperse, which is inconvenient and sometimes expensive to clean up. Spills can also be hazardous if the liquid is a dangerous chemical, or if there are other chemicals or devices that can be contaminated or affected by the spilt liquid.

One common safety precaution for graduated cylinders is to have a plastic bumper guard that surrounds the circumference of the graduated cylinder near the top, to minimize the chance of the glass breaking when the cylinder topples over. However, the bumper guard does not guarantee that the glass will not break when toppled over, nor does it prevent hazards from chemical spills when the graduated cylinder is toppled.

The present invention, detailed below, offers several embodiments that help secure a graduated cylinder in an upright position to prevent the cylinder from being toppled over. By securing the graduated cylinder, both the hazards from glass breakage and chemical spills can be prevented.

### DESCRIPTION OF THE INVENTION

### External Vacuum Embodiment

This embodiment is illustrated in FIGS. 1-3.

A graduated cylinder 100A has a liquid holding portion 200A, and a glass base 300. Preferably the glass base 300 is in the shape of a truncated hyperboloid. On the side of the hyperboloid base 300, a side-arm 400 is present to provide pneumatic access to the hollow cavity 320 inside the hyperboloid base 300. Then, a number of methods can be used to create a vacuum inside the cavity 320, through the side-arm 400. To secure the graduated cylinder 100A in an upright position, the cylinder 100A must be placed onto a flat or substantially flat surface 50A. Using methods detailed below, a vacuum is then created within the base cavity 320. By creating a vacuum, the pressure inside the cavity 320 is much lower than the atmospheric pressure outside the hyperboloid base 300. This results in a net downwards force pushing down on the hyperboloid base 300, resulting in a “suction-cup-like” force that keeps the graduated cylinder 100A in an upright position.

One method of creating a vacuum in the cavity 320 is to use a standard vacuum pump device that connects to the side-arm opening 410 through a tube. The pump can then be turned on to create a vacuum within the cavity 320. After a vacuum is created, the pump can remain connected to maintain the vacuum, or an optional valve 420 built into the side-arm 400 can then be closed to prevent air from entering the cavity 320, which would allow the pump to be turned off or disconnected while maintaining a vacuum. Many laboratories also have built in vacuum pumps into laboratory workbenches that can be easily attached and used to create the vacuum.

A second method of creating a vacuum through the side-arm 400 is using a water aspirator. The water aspirator can be connected to the side-arm opening 410 and create a moderate vacuum in the cavity 320 by running water through the water aspirator. Again, the difference in air pressure between the vacuum in the cavity 320 and the atmospheric pressure outside of the base 300 results in a net downwards force on the hyperboloid base 300 that keeps the graduated cylinder 100A in an upright position. The water aspirator can run throughout the use of the graduated cylinder 100A to maintain the vacuum, or the optional valve 420 can be turned to a closed position to maintain the vacuum, allowing the aspirator to then be turned off or disconnected.

### Internal Vacuum Embodiment

This embodiment is illustrated in FIG. 4.

A graduated cylinder 100B (not shown) has a liquid holding portion 200B (not shown, but the same or substantially the same as in the External Vacuum Embodiment), and a truncated hyperboloid base 500 without a side-arm extension. The base 500 comprises a frame 510 with a hollow cavity 520. When placed onto a flat surface 530, a vacuum can be formed in cavity 520 using a vacuum pump. The vacuum pump can be built into the laboratory workstation or flat surface 530 that the graduated cylinder 100B is placed onto, and then pump air out of the cavity 520 through one or more holes 540 that are present within the surface 530. A valve can be placed in the pathway to the one or more holes 540 to close the hole when a vacuum is created in cavity 520, thus maintaining a vacuum within the base 500 that keeps the graduated cylinder 100B in an upright position.

### Suction Cup Embodiment

This embodiment is illustrated in FIGS. 5-7.

A graduated cylinder 100C has a liquid holding portion 200C, and a modified base 600, with the bottom portion being a suction cup 620, to keep the graduated cylinder 100C in an upright position during use. A suction cup is often made of flexible plastic or rubber (e.g., natural rubber or synthetic ones such as polysiloxane). When suction is desired, a user pushes the cup down on a flat surface, which pushes air out of the suction cup. The resulting lower air pressure within the suction cup, compared to the higher atmospheric pressure outside the suction cup, results in a net downwards force on the suction cup that keeps the object in place.

However, suction cups are difficult to remove after being pushed in place, and must often be yanked with great force to remove it from the surface it is attached to. For application with graduated cylinders, this poses a hazard: yanking a graduated cylinder that is attached to a surface with a suction cup can result in liquids accidentally being spilled out of the cylinder, or the graduated cylinder accidentally hitting another object and breaking.

These hazards can be avoided with a graduated cylinder 100C that has a modified base 600. While the lower portion of the base can be a suction cup 620 made of rubber, plastic, or a similar flexible material, the upper portion of the base can be a short glass cylinder 610 that has a valve or slidable opening 630. When a suction force is desired to keep the cylinder 100C in an upright position, the valve or slidable opening 630 is closed, and then the user can push the graduated cylinder 100C down onto the flat surface 50C, creating the suction force by removing some air pressure within the base cavity 640.

When the user desires to remove the graduated cylinder 100C from the surface 50C, the user can then open the valve or slidable opening 630, allowing air to flow into the cavity 640. Once air flows into the cavity 640 and the air pressure in the outside and inside of the base is equalized, the net downwards force on the cylinder base 600 is no longer present, and the user can easily remove the cylinder 100C without having to yank with great force.

The short cylinder portion 610 can also be made of the same material as the suction cup 620, as long as a valve or slidable opening 630 can be integrated into the material to allow airflow into the cavity 640 when desired.

### Magnetic Embodiment

This embodiment is illustrated in FIGS. 8-9.

Magnets can also be used to keep a graduated cylinder 100D in an upright position. The graduated cylinder 100D has a liquid holding portion 200D, and a modified base 700 that has a permanent magnet 710 built into the base. Unlike the other embodiments, a cavity is not necessary in the modified base 700.

The graduated cylinder 100D would rest on a modified surface 800 that has an electromagnet where the magnetism can be turned on and off by controlling the supply of electricity. The electromagnet would consist of a ferromagnetic core 810, a coil 820 that wraps around the core, a switch 830, and a power source 840. When a magnetic force is desired to keep the graduated cylinder 100D in an upright position, the user turns on the magnetism by turning on the switch 830 to supply electricity to the coil 820 of the electromagnet. When the cylinder 100D is desired to be removed from the surface, the user turns off the magnetism by turning off the switch 830 to cut off supply of electricity to the coil 820 of the electromagnet. The modified surface 800 can work as a lab workstation surface as well. Alternatively, the electromagnet can be replaced by a material that is magnetized when it is placed close to the permanent magnet 710. Such material can be selected from iron, nickel, cobalt, any other metals possessing similar properties, and their alloys.

### DESCRIPTION OF THE FIGURES

FIG. 1 depicts a graduated cylinder 100A with a liquid holding portion 200A and a base 300 with the external vacuum embodiment, sitting on a flat surface 500.

FIG. 2 depicts a top view of the graduated cylinder 100A in FIG. 1 from perspective A-A, showing the liquid holding portion 200A, the base 300, and the side-arm 400.

FIG. 3 depicts a side perspective of the cross section B-B of the base 300.

FIG. 4 depicts a graduated cylinder 100B with a modified base 500 as per the internal vacuum embodiment, which rests on a modified surface 530 that has one or more holes 540 where a vacuum pump can create a vacuum in cavity 520.

FIG. 5 depicts a graduated cylinder 100C with a modified base 600 per the suction cup embodiment.

FIG. 6 shows a top view of the graduated cylinder 100C with the suction cup embodiment, from the perspective C-C.

FIG. 7 shows the side cross-section of the modified base 600, from the side perspective D-D, as well as the surface 50 that the base 600 rests on.

FIG. 8 depicts a graduated cylinder 100D with a modified magnetic base 700.

FIG. 9 depicts a side cross-section of a modified surface 800 with a magnet that can be turned on and off, as well as the modified base 700 sitting on top of the modified surface 800.

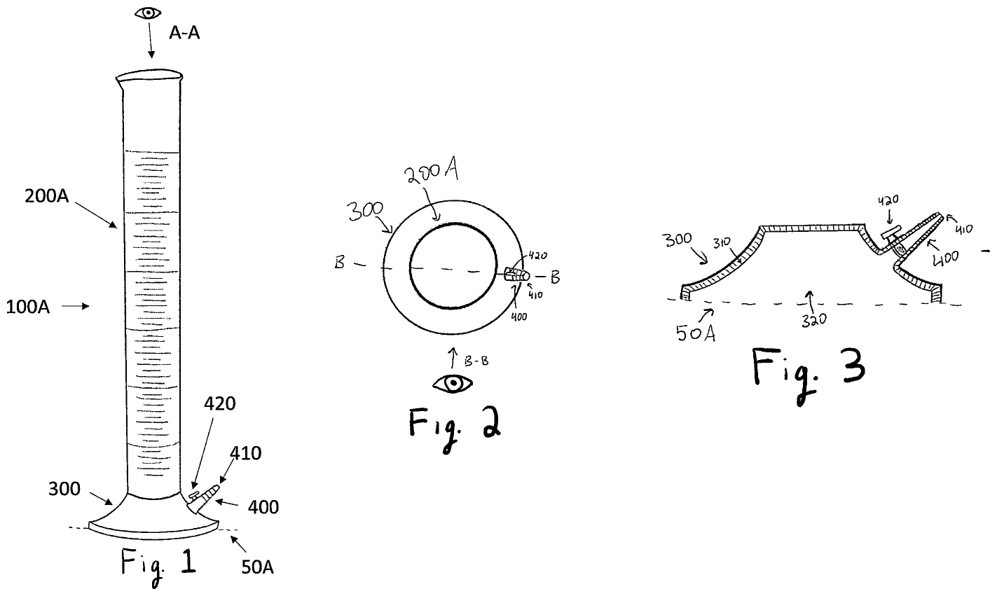

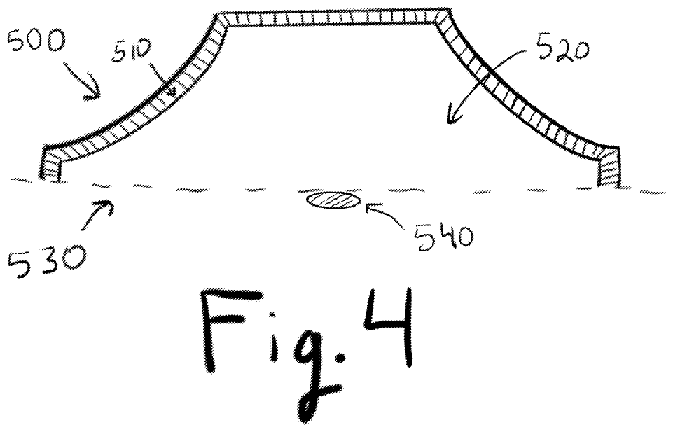

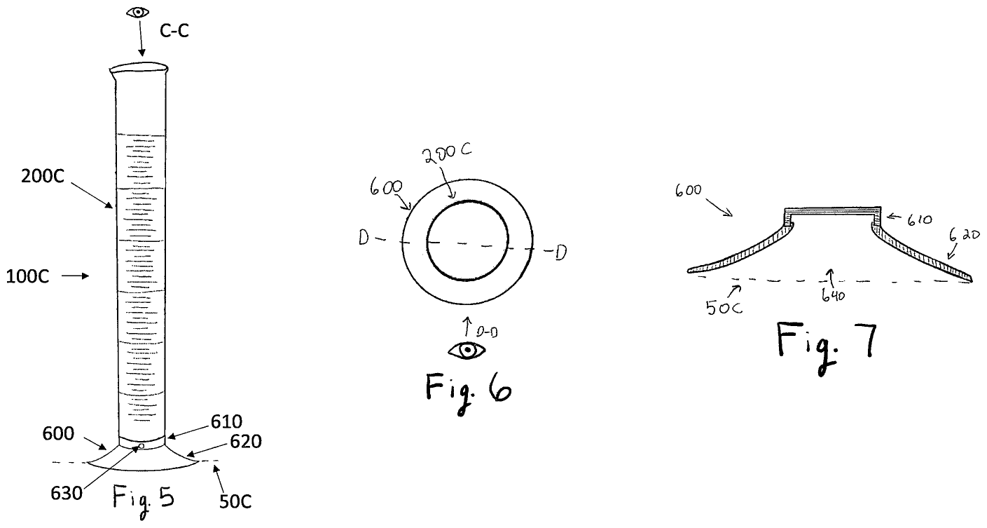

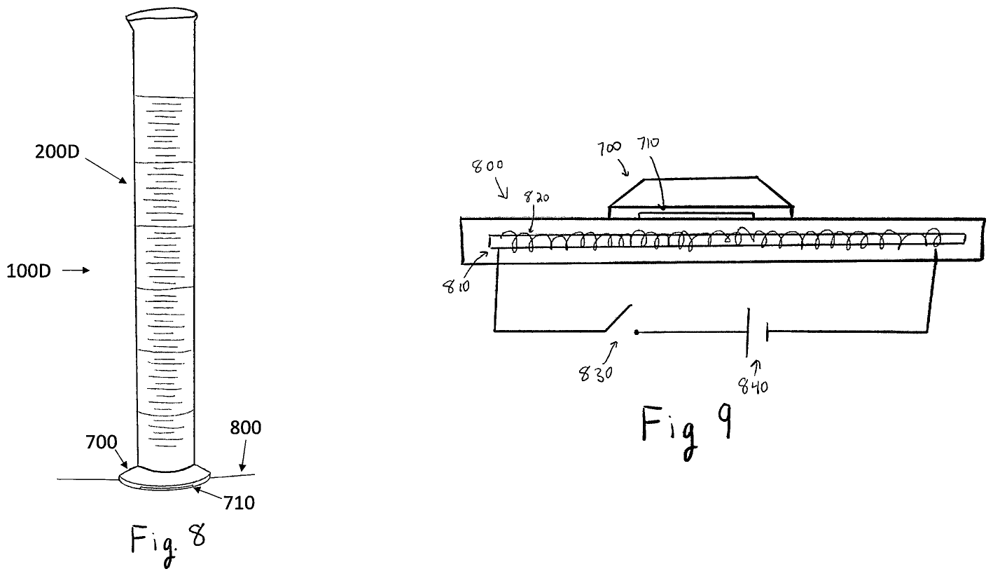

1. (canceled)

2. A graduated cylinder comprising:
a liquid holding portion;
a base comprising a side-arm having a valve having an open position and a closed position, and a cavity within said base;
wherein the side-arm is adapted for connecting to a vacuum source;
wherein when the vacuum source is connected to the side-arm and the valve is placed in the open position and said base is placed on a flat surface, vacuum is created in the cavity of said base that keeps said graduated cylinder upright;
wherein when the valve is turned to the closed position, vacuum is maintained in the cavity of the said base; and
wherein when the vacuum source is disconnected from the side-arm and the valve is turned to the open position, vacuum in the cavity of said base is lost and said graduated cylinder can be removed from said flat surface.

3. (canceled)

4. A graduated cylinder comprising:
a liquid holding portion;
a base comprising a suction cup portion, a cavity within said base, and a valve or slidable opening in the base that connects to said cavity;
wherein when the valve or slidable opening is closed and said base is placed on a flat surface, said suction cup portion can be pushed onto said flat surface to lower the air pressure within said cavity and keep said graduated cylinder upright; and
wherein when the valve or slidable opening is closed, air pressure is restored within said cavity and said graduated cylinder can be removed from said flat surface.

5. A graduated cylinder containing:
a liquid holding portion;
a base having a permanent magnet;
a flat surface with an electromagnet that can be turned on and off;
wherein when the electromagnet is turned on, said graduated cylinder can be placed onto said flat surface to keep said graduated cylinder upright; and
wherein when the electromagnet is turned off, said graduated cylinder can be removed from said flat surface.
